(19) United States
(12) Patent Application Publication
(10) Pub. No.: US 2011/0316779 A1
(43) Pub. Date: Dec. 29, 2011

(54) MOUSE DEVICE WITH MICROPHONE

(75) Inventor: Yi-Guang Chen, Taipei (TW)

(73) Assignee: PRIMAX ELECTRONICS LTD., Taipei (TW)

(21) Appl. No.: 12/860,025

(22) Filed: Aug. 20, 2010

(30) Foreign Application Priority Data
Jun. 25, 2010 (TW) 099120854

(51) Int. Cl. G06F 3/033; H04R 1/02

(52) U.S. Cl. 345/163; 381/91

(57) ABSTRACT

A mouse device includes a mouse base, a mouse casing, a first button, a second button, a microphone module and a controlling unit. The first button and the second button have different structures. By clicking the first button and the second button, a first sound and a second sound having different frequencies are respectively generated. The first sound and the second sound are received by the microphone module. According to the frequency of the first sound or the second sound, a first button command or a second button command is generated.

### FIELD OF THE INVENTION

The present invention relates to a mouse device, and more particularly to a mouse device with a microphone.

### BACKGROUND OF THE INVENTION

With increasing development of science and technology, for most people, computers become essential electronic devices in daily lives. In a computer system, an input device plays an important role for communicating the computer host and the user. The common input device includes for example a mouse device, a keyboard or a trackball. Among these input devices, the mouse device is the most prevailing because it is very easy-to-use. When a mouse device is held on the palm of a user's hand, the user may move the mouse device to control movement of the cursor shown on the computer screen. In addition, by manipulating the buttons of the mouse device, the user may point and click a desired icon shown on the computer monitor or execute a corresponding function.

Hereinafter, the configurations and the functions of a mouse device will be illustrated by referring to a wheel mouse device. FIG. 1 is a schematic diagram illustrating the connection between a conventional wheel mouse device and a computer system. The computer system 2 comprises a computer host 21 and a computer monitor 22. The computer host 21 is in communication with the wheel mouse device 1 and the computer monitor 22. A cursor 221 and a graphic-based window 222 are displayed on the computer monitor 22. The wheel mouse device 1 is used for controlling the cursor 221 such that the computer host 21 executes a corresponding instruction. The wheel mouse device 1 comprises a mouse body 10, a left button 11, a right button 12 and a scroll wheel 13. The mouse body 10 is used for supporting a user's palm. The mouse body 10 is moved by the user to result in a displacement amount. According to the displacement amount, the computer host 21 correspondingly moves the cursor 221 shown on the computer screen 22. By clicking the left button 11 or the right button 12, a control signal is issued to the computer host 21. In response to the control signal, the computer host 21 executes a corresponding instruction. By rotating the scroll wheel 13, the graphic-based window 222 shown on the computer monitor 21 may be scrolled upwardly or downwardly.

Hereinafter, the internal structure of a conventional wheel mouse device will be illustrated with reference to FIG. 2. FIG. 2 is a schematic cutaway view illustrating a conventional wheel mouse device. The mouse body 10 of the wheel mouse device 2 comprises a mouse base 101 and a mouse casing 102. The mouse base 101 is covered by the mouse casing 102. A portion of the scroll wheel 13 is protruded from the mouse casing 102. A left button 11 is exposed to the mouse casing 102. The left button 11 has a left button triggering part 111. Similarly, a right button 12 is exposed to the mouse casing 102. The right button 12 has a right button triggering part 121. The wheel mouse device 2 further comprises a circuit board 14, a left switch 15, a right switch 16 and a displacement detecting module (not shown). The circuit board 14 is disposed on the mouse base 101. The left switch 15 and the right switch 16 are mounted on the circuit board 14. The displacement detecting module is used for detecting a motion of the mouse body 10, and generating a corresponding control signal. When the left button 11 is pressed down, the left button 11 is moved downwardly with respect to the mouse casing 102, and thus the left switch 15 is triggered by the left button triggering part 111 to generate a left button signal. Similarly, when the right button 12 is pressed down, the right button 11 is moved downwardly with respect to the mouse casing 102, and thus the right switch 16 is triggered by the right button triggering part 121 to generate a right button signal.

It is found from the above discussions that, for operating the left button 11 and the right button 12 of the conventional wheel mouse device 2, the left switch 15 and the right switch 16 should be respectively triggered by the left button triggering part 111 and the right button triggering part 121 to generate the signals corresponding to the left button 11 and the right button 12. Recently, with increasing development of the mouse technology, various mouse devices have been developed in order to meet diversified demands. Generally, most users preferring the slim type mouse devices because they are easily carried. Since the space within the mouse device is limited and the components of the mouse device as shown in FIG. 2 are indispensable, it is difficult to further minimize the overall volume of the mouse device.

### SUMMARY OF THE INVENTION

The present invention provides a mouse device with a microphone, in which no switch corresponding to the button is installed on the mouse device.

In accordance with an aspect of the present invention, there is provided a mouse device with a microphone. The mouse device includes a mouse base, a mouse casing, a first button, a second button, a microphone module and a controlling unit. The mouse base is covered by the mouse casing. The first button disposed on the mouse casing. When the first button is clicked, a first sound is generated. The second button is disposed on the mouse casing, and arranged beside the first button. When the second button is clicked, a second sound is generated. The microphone module is arranged between the mouse base and the mouse casing for receiving the first sound or the second sound, converting the first sound into a first sound signal, and converting the second sound into a second sound signal. The controlling unit is electrically connected to the microphone module for judging whether the first sound signal is within a first frequency range or within a second frequency range, or judging whether the second sound signal is within the first frequency range or within the second frequency range. If the first sound signal is within the first frequency range, the controlling unit issues a first button command. If the second sound signal is within the second frequency range, the controlling unit issues a second button command.

In an embodiment, the first button includes a hollow structure. The hollow structure is formed in a first surface of the first button. A second surface of the first button is exposed to a surface of the mouse casing. When the first button is clicked, a first sound wave is generated, and the first sound wave passes through the hollow structure, so that the first button generates the first sound.

In an embodiment, the second button includes a solid structure. The solid structure is formed on a first surface of the second button. A second surface of the second button is exposed to the surface of the mouse casing. When the second button is clicked, a second sound wave is generated, and the second sound wave passes through the solid structure, so that the second button generates the second sound, wherein the second sound and the first sound are different.

In an embodiment, the first button includes a first hollow structure. The first hollow structure is formed in a first surface of the first button. A second surface of the first button is exposed to a surface of the mouse casing. When the first button is clicked, a first sound wave is generated, and the first sound wave passes through the first hollow structure, so that the first button generates the first sound.

In an embodiment, the second button includes a second hollow structure. The second hollow structure is formed in a first surface of the second button. A second surface of the second button is exposed to the surface of the mouse casing. The second hollow structure is larger than the first hollow structure. When the second button is clicked, a second sound wave is generated, and the second sound wave passes through the second hollow structure, so that the second button generates the second sound, wherein the second sound and the first sound are different.

In an embodiment, the first sound signal issued from the microphone module is a first sound analog signal. The first sound analog signal is converted into a first sound digital signal by the controlling unit. The controlling unit judges whether the first sound digital signal is within the first frequency range or within the second frequency range. The second sound signal issued from the microphone module is a second sound analog signal. The second sound analog signal is converted into a second sound digital signal by the controlling unit. The controlling unit judges whether the second sound digital signal is within the second frequency range.

In an embodiment, the mouse device further includes a circuit board and a displacement sensing module. The circuit board is disposed on the mouse base. The microphone module and the controlling unit are disposed on the circuit board. The displacement sensing module is disposed on the circuit board and exposed to the mouse base for detecting a motion of the mouse casing.

In an embodiment, the mouse device further includes a scroll wheel, which is disposed on the mouse base and partially protruded out of the mouse casing.

In an embodiment, the button is a left button, the second button is a right button, and the first button and the second button are integrally formed with the mouse casing.

In an embodiment, the button is a right button, and the second button is a left button.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic diagram illustrating the connection between a conventional wheel mouse device and a computer system;

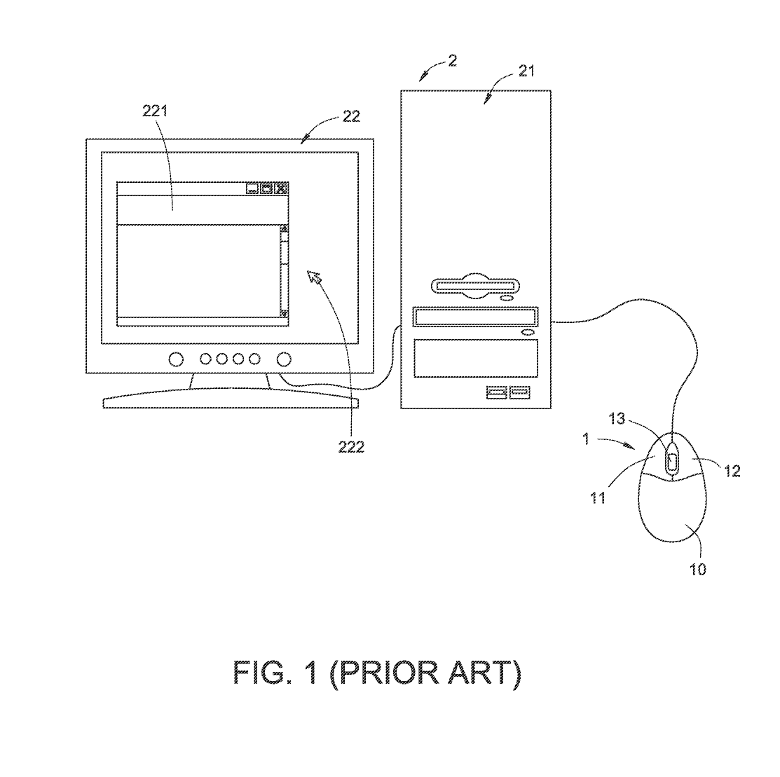

FIG. 2 is a schematic cutaway view illustrating a conventional wheel mouse device;

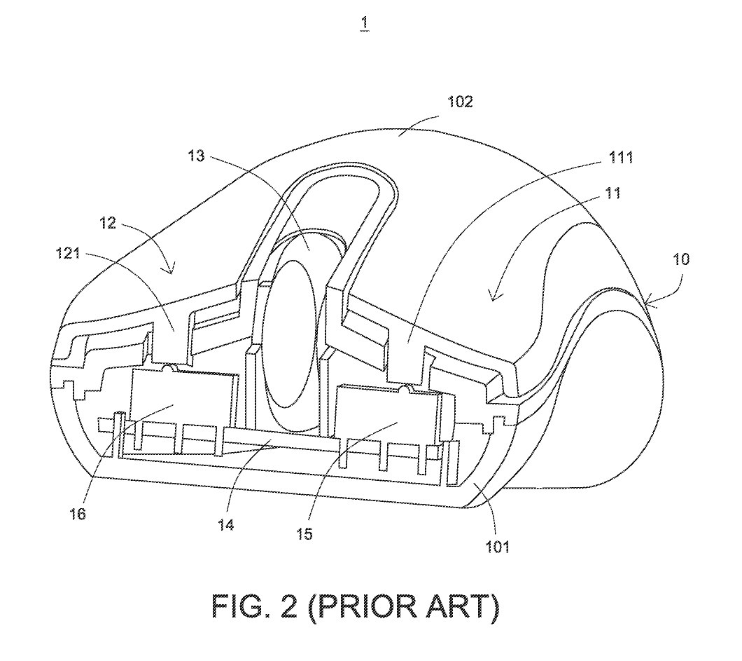

FIG. 3 is a schematic cutaway view illustrating a mouse device with a microphone according to a first embodiment of the present invention;

FIG. 4 is a schematic side view illustrating the mouse device as shown in FIG. 3;

FIG. 5 is a schematic cutaway view illustrating a mouse device with a microphone according to a second embodiment of the present invention; and

FIG. 6 is a schematic side view illustrating the mouse device as shown in FIG. 5.

### DETAILED DESCRIPTION OF THE PREFERRED EMBODIMENT

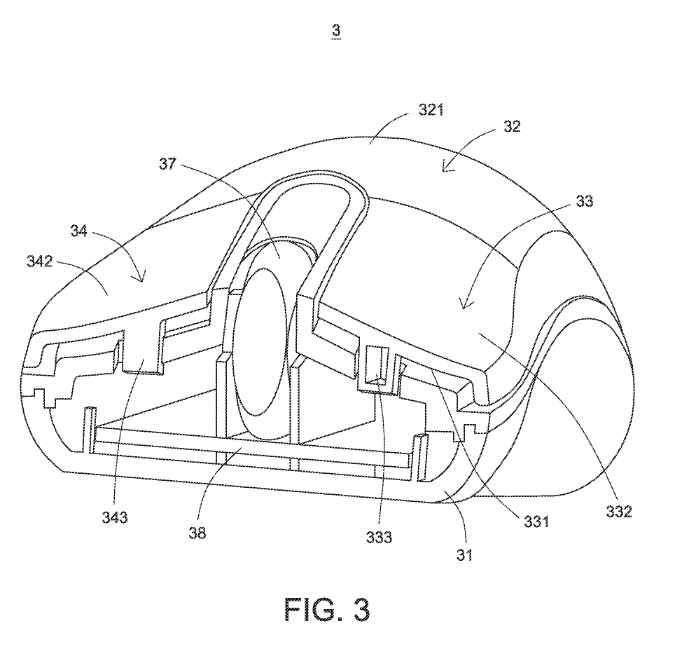

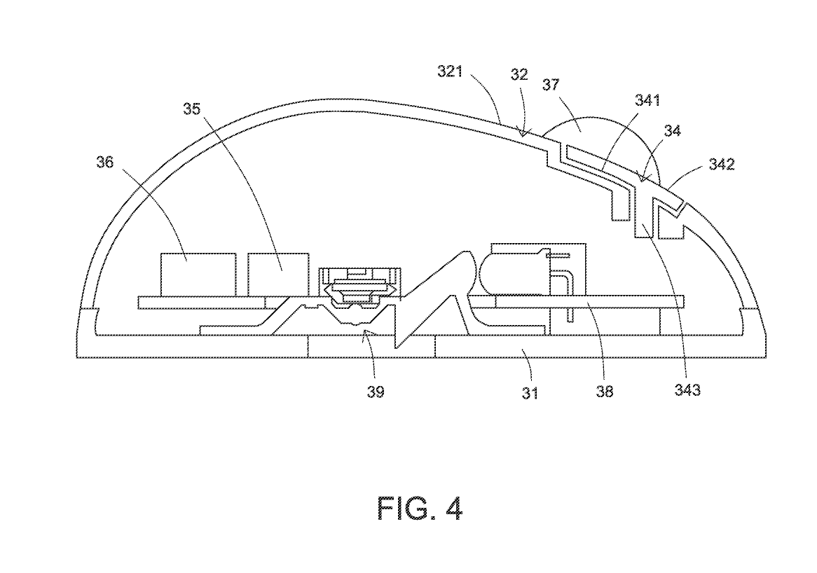

For obviating the drawbacks encountered from the prior art, the present invention provides a mouse device with a microphone. FIG. 3 is a schematic cutaway view illustrating a mouse device with a microphone according to a first embodiment of the present invention. FIG. 4 is a schematic side view illustrating the mouse device as shown in FIG. 3. Please refer to FIGS. 3 and 4. The mouse device 3 comprises a mouse base 31, a mouse casing 32, a first button 33, a second button 34, a microphone module 35, a controlling unit 36, a scroll wheel 37, a circuit board 38 and a displacement sensing module 39.

The mouse base 31 is covered by the mouse casing 32. The scroll wheel 37 is disposed on the mouse base 31, and partially protruded out of the mouse casing 32. By rotating the scroll wheel 37, a scrolling signal is generated. The first button 33 is disposed on the mouse casing 32. A second surface 332 of the first button 33 is exposed to a surface 321 of the mouse casing 32. The first button 33 has a hollow structure 333. The hollow structure 333 is formed in a first surface 331 of the first button 33. The second button 34 is disposed on the mouse casing 32, and arranged beside the first button 33. A second surface 342 of the second button 34 is exposed to the surface 321 of the mouse casing 32. The second button 34 has a solid structure 343. The solid structure 343 is disposed on a first surface 341 of the second button 34

The circuit board 38 is disposed on the mouse base 31. The microphone module 35, the controlling unit 36 and the displacement sensing module 39 are disposed on the circuit board 38. The microphone module 35 and the displacement sensing module 39 are in communication with the controlling unit 36. The displacement sensing module 39 is exposed to the mouse base 31 for detecting a motion of the mouse casing 32. In this embodiment, the first button 33 is a left button, the second button 34 is a right button, and the controlling unit 36 is a microprocessor.

A first frequency range and a second frequency range are preset in the controlling unit 36. The first frequency range and the second frequency range are digital value ranges of sound frequency. For example, the first frequency range is a digital value range from 300 Hz to 400 Hz; and the second frequency range is a digital value range from 200 Hz to 300 Hz.

Hereinafter, the operations of the mouse device 3 will be illustrated with reference to FIGS. 3 and 4. By clicking the first button 33, a sound wave is generated. The sound wave passes through the hollow structure 333 of the first button 33, so that the first button 33 generates a first sound. The first sound is received by the microphone module 35, which is arranged between the mouse base 31 and the mouse casing 32. The first sound is converted into a first sound signal by the microphone module 35, and the first sound signal is transmitted to the controlling unit 36. The first sound signal is a first sound analog signal. When the first sound analog signal is received by the controlling unit 36, the first sound analog signal is converted into a first sound digital signal by the controlling unit 36. Then, the controlling unit 36 will judge whether the first sound digital signal is within the first frequency range or within the second frequency range. In this embodiment, the predetermined frequency of the sound that is generated by clicking the first button 33 is ranged between 300 Hz and 400 Hz. That is, the controlling unit 36 judges that the first sound digital signal is within the first frequency range. As such, the controlling unit 36 issues a first button command.

By clicking the second button 34, another sound wave is generated. This sound wave passes through the solid structure 343 of the second button 34, so that the second button 34 generates a second sound. The second sound is received by the microphone module 35, which is arranged between the mouse base 31 and the mouse casing 32. The second sound is converted into a second sound signal by the microphone module 35, and the second sound signal is transmitted to the controlling unit 36. The second sound signal is a second sound analog signal. When the second sound analog signal is received by the controlling unit 36, the second sound analog signal is converted into a second sound digital signal by the controlling unit 36. Then, the controlling unit 36 will judge whether the second sound digital signal is within the first frequency range or within the second frequency range. In this embodiment, the predetermined frequency of the sound that is generated by clicking the second button 34 is ranged between 200 Hz and 300 Hz. That is, the controlling unit 36 judges that the second sound digital signal is within the second frequency range. As such, the controlling unit 36 issues a second button command.

It is noted that, since the first button 33 has the hollow structure 333, the sound wave generated by clicking the first button 33 will pass through the hollow structure 333 and cause resonance in the hollow structure 333. The another sound wave generated by clicking the second button 34 will pass through the solid structure 343 and cause tiny resonance in the solid structure 343. As such, the frequency of the first sound received by the microphone module 35 is higher than the frequency of the second sound received by the microphone module 35. That is why the first frequency range preset in the controlling unit 36 is higher than the second frequency range preset in the controlling unit 36. In the above embodiment, the mouse device 3 generates different sounds when the first button 33 and the second button 34 are clicked. That is, the controlling unit 36 can judge which button is the clicked button.

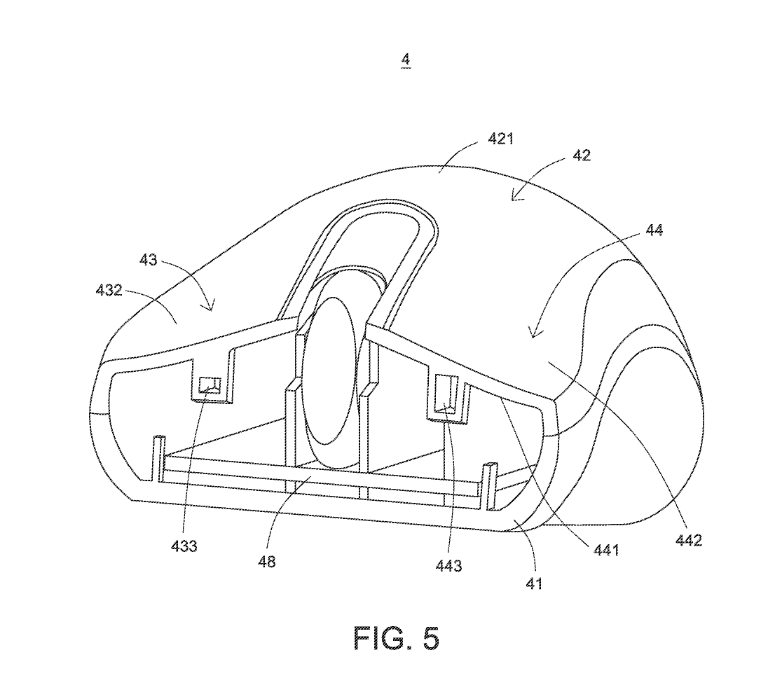

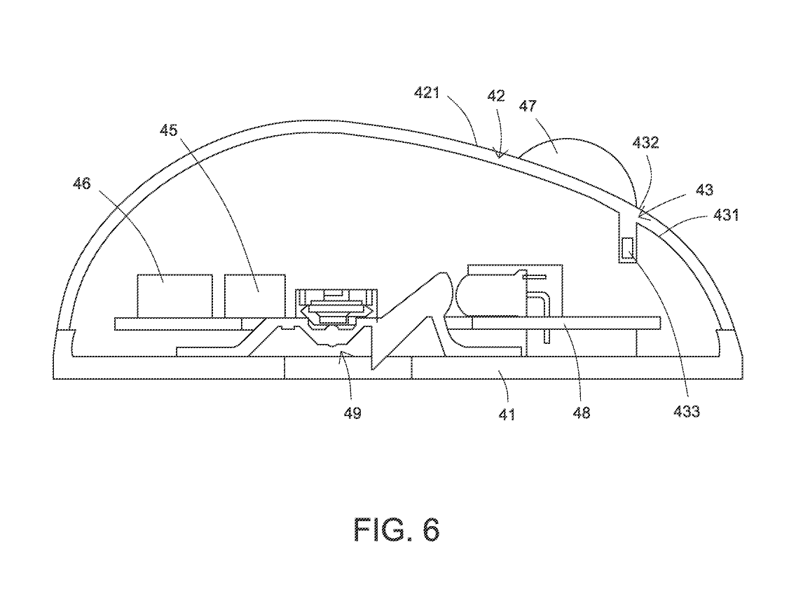

The present invention further provides a second embodiment of a mouse device. FIG. 5 is a schematic cutaway view illustrating a mouse device with a microphone according to a second embodiment of the present invention. FIG. 6 is a schematic side view illustrating the mouse device as shown in FIG. 5. Please refer to FIGS. 5 and 6. The mouse device 4 comprises a mouse base 41, a mouse casing 42, a first button 43, a second button 44, a microphone module 45, a controlling unit 46, a scroll wheel 47, a circuit board 48 and a displacement sensing module 49.

The configurations of the mouse base 41, the microphone module 45, the controlling unit 46, the scroll wheel 47, the circuit board 48 and the displacement sensing module 49 are identical to those illustrated in the first embodiment, and are not redundantly described herein. In comparison with the first embodiment, the first button 43 and the second button 44 of the mouse device 4 of this embodiment comprise a first hollow structure 433 and a second hollow structure 443, respectively. The first hollow structure 433 is formed in a first surface 431 of the first button 43. A second surface 432 of the first button 43 is exposed to a surface 421 of the mouse casing 42. The second hollow structure 443 is formed on a first surface 441 of the second button 44. A second surface 442 of the second button 44 is exposed to a surface 421 of the mouse casing 42. In this embodiment, the first button 43 is a right button, and the second button 44 is a left button. Moreover, the first button 43 and the second button 44 are integrally formed with the mouse casing 42.

Hereinafter, the operations of the mouse device 4 will be illustrated with reference to FIG. 5. By clicking the first button 43, a sound wave is generated. The sound wave passes through the first hollow structure 433 of the first button 43, so that the first button 43 generates a first sound. The first sound is received by the microphone module 45, which is arranged between the mouse base 41 and the mouse casing 42. The first sound is converted into a first sound signal by the microphone module 45, and the first sound signal is transmitted to the controlling unit 46. The first sound signal is a first sound analog signal. When the first sound analog signal is received by the controlling unit 46, the first sound analog signal is converted into a first sound digital signal by the controlling unit 46. Then, the controlling unit 46 will judge whether the first sound digital signal is within the first frequency range or within the second frequency range.

By clicking the second button 44, another sound wave is generated. This sound wave passes through the second hollow structure 443 of the second button 44, so that the second button 44 generates a second sound. The second sound is received by the microphone module 45, which is arranged between the mouse base 41 and the mouse casing 42. The second sound is converted into a second sound signal by the microphone module 45, and the second sound signal is transmitted to the controlling unit 46. The second sound signal is a second sound analog signal. When the second sound analog signal is received by the controlling unit 46, the second sound analog signal is converted into a second sound digital signal by the controlling unit 46. Then, the controlling unit 46 will judge whether the second sound digital signal is within the first frequency range or within the second frequency range

By comparing the first sound digital signal with the first frequency range and the second frequency range, the controlling unit 46 judges that the first sound digital signal is within the first frequency range. As such, the controlling unit 46 issues a first button command. Similarly, by comparing second first sound digital signal with the first frequency range and the second frequency range, the controlling unit 46 judges that the second sound digital signal is within the second frequency range. As such, the controlling unit 46 issues a second button command.

It is noted that, since the first button 43 has the first hollow structure 433, the sound wave generated by clicking the first button 43 will pass through the first hollow structure 433 and cause resonance in the first hollow structure 433. Similarly, since the second button 44 has the second hollow structure 443 and the second hollow structure 443 is larger than the first hollow structure 433, the sound wave generated by clicking the second button 44 will pass through the second hollow structure 443 and also cause resonance in the second hollow structure 443. Moreover, since the resonance in the second hollow structure 443 is stronger than that in the first hollow structure 433, the frequency of the second sound received by the microphone module 45 is higher than the frequency of the first sound received by the microphone module 45. In the above embodiment, the mouse device 4 generates different sounds when the first button 43 and the second button 44 are clicked. That is, the controlling unit 46 can judge which button is the clicked button.

From the above description, the mouse device of the present invention has a microphone module. Since the first button and the second button of the mouse device have different structures, the sounds generated by clicking the first button and the second button are distinguished from each other and able to be recognized. By means of the first button, the second button, the microphone module and the controlling unit, the ordinary functions that the conventional mouse device has will be implemented by the mouse device of the present invention. In this situation, neither button triggering parts nor switches to be triggered are installed within the mouse device of the present invention. As such, the mouse device has additional space to accommodate other components, or the thickness of the mouse device may be further reduced. Moreover, since no button triggering parts and no switches are installed within the mouse device of the present invention, the limitation of the space utilization within the mouse device will be minimized. As a consequence, the mouse casing of the mouse device of the present invention is easily manufactured and can meet various demands such as the slim-type and ergonomic demands.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A mouse device with a microphone, said mouse device comprising:
a mouse base;
a mouse casing covering said mouse base;
a first button disposed on said mouse casing, wherein when said first button is clicked, a first sound is generated;
a second button disposed on said mouse casing, and arranged beside said first button, wherein when said second button is clicked, a second sound is generated;
a microphone module arranged between said mouse base and said mouse casing for receiving said first sound or said second sound, converting said first sound into a first sound signal, and converting said second sound into a second sound signal; and
a controlling unit electrically connected to said microphone module for judging whether said first sound signal is within a first frequency range or within a second frequency range, or judging whether said second sound signal is within said first frequency range or within said second frequency range, wherein if said first sound signal is within said first frequency range, said controlling unit issues a first button command, wherein if said second sound signal is within said second frequency range, said controlling unit issues a second button command.

2. The mouse device with a microphone according to claim 1 wherein said first button comprises a hollow structure, said hollow structure is formed in a first surface of said first button, and a second surface of said first button is exposed to a surface of said mouse casing, wherein when said first button is clicked, a first sound wave is generated, and said first sound wave passes through said hollow structure, so that said first button generates said first sound.

3. The mouse device with a microphone according to claim 2 wherein said second button comprises a solid structure, said solid structure is formed on a first surface of said second button, and a second surface of said second button is exposed to said surface of said mouse casing, wherein when said second button is clicked, a second sound wave is generated, and said second sound wave passes through said solid structure, so that said second button generates said second sound, wherein said second sound and said first sound are different.

4. The mouse device with a microphone according to claim 1 wherein said first button comprises a first hollow structure, said first hollow structure is formed in a first surface of said first button, and a second surface of said first button is exposed to a surface of said mouse casing, wherein when said first button is clicked, a first sound wave is generated, and said first sound wave passes through said first hollow structure, so that said first button generates said first sound.

5. The mouse device with a microphone according to claim 4 wherein said second button comprises a second hollow structure, said second hollow structure is formed in a first surface of said second button, a second surface of said second button is exposed to said surface of said mouse casing, and said second hollow structure is larger than said first hollow structure, wherein when said second button is clicked, a second sound wave is generated, and said second sound wave passes through said second hollow structure, so that said second button generates said second sound, wherein said second sound and said first sound are different.

6. The mouse device with a microphone according to claim 1 wherein said first sound signal issued from said microphone module is a first sound analog signal, said first sound analog signal is converted into a first sound digital signal by said controlling unit, and said controlling unit judges whether said first sound digital signal is within said first frequency range or within said second frequency range, wherein said second sound signal issued from said microphone module is a second sound analog signal, said second sound analog signal is converted into a second sound digital signal by said controlling unit, and said controlling unit judges whether said second sound digital signal is within said second frequency range.

7. The mouse device with a microphone according to claim 1 wherein said mouse device further comprises:
a circuit board disposed on said mouse base, wherein said microphone module and said controlling unit are disposed on said circuit board; and
a displacement sensing module disposed on said circuit board and exposed to said mouse base for detecting a motion of said mouse casing.

8. The mouse device with a microphone according to claim 1 wherein said mouse device further comprises a scroll wheel, which is disposed on said mouse base and partially protruded out of said mouse casing.

9. The mouse device with a microphone according to claim 1 wherein said button is a left button, said second button is a right button, and said first button and said second button are integrally formed with said mouse casing.

10. The mouse device with a microphone according to claim 1 wherein said button is a right button, and said second button is a left button.
